(19) United States
(12) Patent Application Publication
(10) Pub. No.: US 2011/0141761 A1
(43) Pub. Date: Jun. 16, 2011

(54) ILLUMINATING DEVICE FOR AN ADJUSTING MECHANISM FOR ADJUSTING AN OPERATING PARAMETER IN A VEHICLE

(75) Inventor: Sandra Trujillo Linke, Frankfurt am Main (DE)

(73) Assignee: GM Global Technology Operations LLC, Detroit, MI (US)

(21) Appl. No.: 12/965,678

(22) Filed: Dec. 10, 2010

(30) Foreign Application Priority Data
Dec. 11, 2009 (DE) 102009057951.6

(51) Int. Cl. G02B 6/10; G02B 6/00

(52) U.S. Cl. 362/559; 362/551

(57) ABSTRACT

An illuminating device is provided for an adjusting mechanism adapted to adjust an operating parameter in a vehicle, with a light-transmitting material that extends along the direction of extension and emits light visible to the user in a first and a second section. In order to realize the transition area between the two light-emitting sections concise and such that it can be easily recognized by the user, it is proposed that the light-transmitting material features a light-transmitting transition area with reduced material thickness between the first and the second section referred to the direction of extension.

### CROSS-REFERENCE TO RELATED APPLICATION

This application claims priority to German Patent Application No. 102009057951.6, filed Dec. 11, 2009, which is incorporated herein by reference in its entirety.

### TECHNICAL FIELD

The technical field pertains to an illuminating device for an adjusting mechanism for adjusting an operating parameter in a vehicle, with a light-transmitting material that extends along the direction of extension and emits light visible to the user in a first and a second section.

### BACKGROUND

An illumination device is known from German Patent DE 102 25 016 B4, which describes an actuating button that is surrounded by a light-transmitting body radially referred to the viewing direction. Several LEDs that protrude into the light-transmitting body serve as the light source. The light-transmitting body appears as an annular luminous area to the observer or the user, respectively. The LEDs are arranged in the pitch circle of an annular printed circuit board concentric to the light-transmitting body and graduated with respect to their color and/or brightness. Due to this measure, the luminous area emits light of different color and/or brightness in different sections of the pitch circle. Since the different regions are not separated, the light mixes at the transitions between the sections. This mixing complicates the allocation of the adjusted position to a value to be adjusted and therefore the use of the adjusting mechanism. In addition, the time required by the user for pinpointing the respectively adjusted position is comparatively long; this may lead to a subjectively perceived sacrifice of comfort.

In light of these circumstances, at least one objective of designing an illuminating device of the initially cited type in such a way that the transition area between the two light-emitting sections is concise and realized such that it can be easily recognized by the user—namely also in the sense of a “vehicle identity.” In addition, other objectives, desirable features and characteristics will become apparent from the subsequent summary and detailed description, and the appended claims, taken in conjunction with the accompanying drawings and this background.

### SUMMARY

An illuminating device is provided with light-transmitting material features and a light-transmitting transition area with reduced material thickness between the first and the second section referred to the direction of extension. The light-transmitting material may be realized in various forms such as, for example, as a translucent, opalescent plastic material, Plexiglas or an optical fiber.

The term adjusting mechanism refers to various designs of a mechanism suitable for adjusting a parameter such as, for example, handles, actuating buttons or control elements that may be realized in the form of rotary controllers, dials and/or sliding controllers or even pushbuttons. In the adjusting direction, these adjusting mechanisms may assume other or a plurality of different adjusting positions between a minimum value (a first end position) and a maximum value (a second end position). It would also be conceivable to use adjusting mechanisms that can assume a smaller number of discrete adjusting positions.

The term operating parameter should be interpreted broadly and may concern various functions such as, for example, the volume, the treble/bass or the balance of a car radio. Operating parameters could also consist of adjustable functions of a heating and/or air-conditioning system such as, for example, the temperature, the fan speed and the air distribution. Likewise, adjustments of a navigation system or a telephone could also be realized by utilizing the inventive device.

One significant advantage is the easily recognizable transition area between the two light-emitting sections. This transition area therefore can effectively be designed in the form of a distinguishing mark that can be easily recognized and used for achieving an improved identification or recognizability (“vehicle identity”). In addition, the inventive illuminating device not only allows a simple allocation of an adjusted position to an operating state, but also an intuitively and easily ascertainable display or depiction of functional states and operating states or of the general adjusting positions of the adjusting mechanism in a vehicle.

One exemplary embodiment, to which the description particularly refers below without thusly restricting the scope, is the control and display of the air-conditioning system or the interior temperature (HVAC) of a vehicle. In this case, it would be conceivable, e.g., that the first light-emitting section assumes the color blue in order to represent cold and the second section assumes the color red in order to represent heat. In one design, in which the light-transmitting material is arranged along the adjusting mechanism, for example, a dial of the adjusting mechanism points to the blue or the red section, depending on the adjusted position. In this case, setting the adjusting mechanism to the blue section may result in the vehicle interior being cooled while setting the adjusting mechanism to the red section may result in the vehicle interior being heated. It would also be conceivable that adjusting positions in the blue section represent a temperature range of the vehicle interior that lies below a certain value and adjusting positions in the red section represent temperatures above this value. In this case, the transition area corresponds to the aforementioned value that may represent, for example, an ideal value or suggested value.

Since the current adjustment of the respective function therefore can be intuitively and quickly ascertained by the vehicle user or driver, there a contribution to improved user-friendliness and vehicle comfort.

In one embodiment, the reduced material thickness is realized with a recess that extends transverse to the direction of extension. This design of the transition area between the first and the second section of the light-transmitting material makes it possible to realize a particularly concise transition that also can be easily realized and configured with respect to the manufacturing technology. Consequently, the transition area between the two sections is defined in greater detail. The recess may be realized, for example, in a V-shaped or U-shaped fashion, where an optically mellower transition can be achieved by avoiding sharp edges, such as in the V-shape.

According to another embodiment, the light-transmitting material has two ends, on which at least one lamp that emits light into the material is respectively arranged. This provides the advantage that the illuminating device is realized with a simple design, namely with only two lamps arranged on the ends. For example, the lamps emit light into the light-transmitting material in a first and a second light in-fed area referred to the direction of extension or the axial direction of the illuminating device. In this case, the light is partially deflected laterally on its path through the light-transmitting material and perceived as emitted light by the observer. A portion of the light propagates in the material up to the transition area. A small portion thereof furthermore crosses the transition area in the material. This light mixes with the light arriving from the opposite direction, which is referred to the direction of extension. The lamps may be realized, for example, in the form of a light-emitting diode (LED).

According to another embodiment, the light emitted by the first section differs from the light emitted by the second section. Due to this design, the two sections can be easily perceived as different sections. In addition to the reduced material thickness, the mixing area between the two sections of the light-transmitting material in the embodiment described here also leads to an optically perceivable differentiation between the two sections.

According to another embodiment, the light emitted by the first section differs from the light emitted by the second section with respect to its wavelength. In this way, a first and a second, different color, which can be optically distinguished by the user, are realized such that an intuitive depiction of the currently adjusted value is achieved depending on the scope of application. In the aforementioned example of a temperature display device, the first color may be blue in order to represent cold and the second color may be red in order to represent heat. This informs the user with simple means how intensely the heater heats or the air-conditioner cools the vehicle interior.

According to another embodiment, the light emitted by the first section differs from the light emitted by the second section with respect to its brightness. This design is particularly advantageous for operating parameters that reflect the magnitude or the intensity of a certain function or a physical parameter. In volume controls, for example, the two sections may intuitively depict that a certain volume level has been exceeded.

According to another embodiment, the light-transmitting material forms a display area; in this case, a display, e.g., in the form of stationary numerical or scale values, may be directly applied onto the light-transmitting material. This embodiment provides the advantage that the currently adjusted position of the adjusting mechanism can be read particularly well and is qualifiedly or evaluable for the user. It would be conceivable, for example, to realize a display area that is arranged along the adjusting mechanism in the direction of extension and furthermore features distinguishing marks, e.g., scale values.

In another embodiment, a display unit that displays numerical adjusted values is arranged along the display area. In a temperature control, the selectable temperature values can be displayed on a scale in this fashion. The actually adjusted value of an operating parameter can be read in a particularly accurate fashion in this case based on the position of the adjusting mechanism.

In yet another embodiment, the material thickness of the light-transmitting material initially decreases continuously in the direction of extension, namely between a first light infeed area and a second light infeed area, and then continuously increases once again from a minimum. This makes it possible to realize a particularly mellow overall impression that is approximately constant with respect to the color intensity and therefore very appealing.

According to another embodiment, the illuminating device can be moved together with the adjusting mechanism; this allows a particularly appealing and very user-friendly design because the transition area formed between the sections may in this respect serve as a dial or indicator that is moved together with the adjusting mechanism.

### BRIEF DESCRIPTION OF THE DRAWINGS

The present invention will hereinafter be described in conjunction with the following drawing figures, wherein like numerals denote like elements, and:

FIG. 1 shows a first exemplary embodiment of a device;

FIG. 2 shows a first variation of the device;

FIG. 3 shows a second embodiment of the device; and

FIG. 4 shows a third embodiment of the device.

### DETAILED DESCRIPTION

The following detailed description is merely exemplary in nature and is not intended to limit application and uses. Furthermore, there is no intention to be bound by any theory presented in the preceding background or summary or the following detailed description.

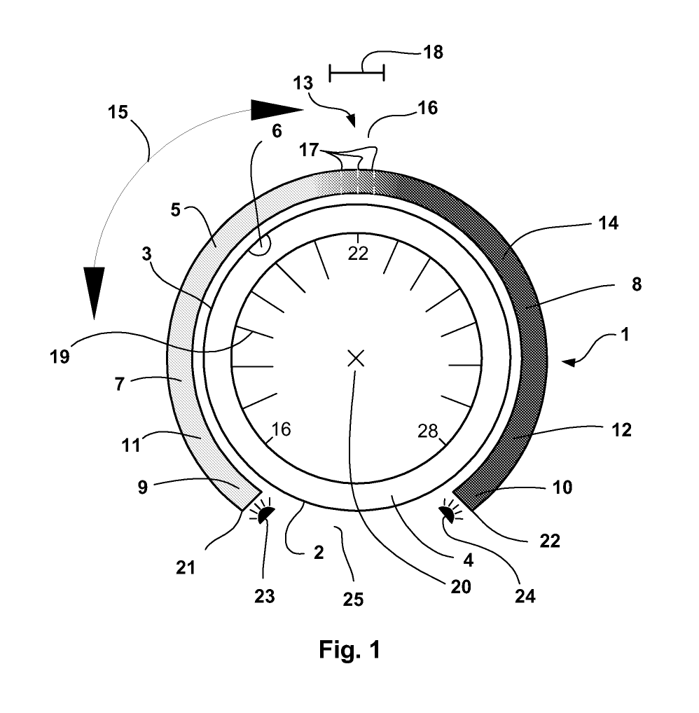

FIG. 1 shows an inventive illuminating device 1 that forms part of an adjusting mechanism 2 for the heating and air-conditioning system of a vehicle with an adjusting device 3 that is realized in the form of a rotary controller 4 in this case. The device furthermore features a display area 5. The position of a dial 6 changes depending on the adjusted position of the rotary controller 4. The illuminating device has at least two sections 7, 8 that differ with respect to their brightness 9, 10 or color 11, 12. The sections 7, 8 represent light-emitting areas and converge toward a transition area 13. In other words: the two sections 7, 8 emit light with different intensity and/or different (visible) wavelength and consequently in different colors 11, 12 that can be easily perceived by the user in each of the possible operating or emitting states.

In the transition area 13 between the sections 7 and 8, a light-transmitting material 14 of the illuminating device has a reduced material thickness 16 in the direction of extension 15 of the adjusting mechanism or in the main direction of extension of the material 14, respectively. This reduced material thickness may be realized with a U-shaped or V-shaped notch or material recess 17 that extends transverse to the direction of extension. This notch or recess is preferably arranged on the rear side referred to the viewing direction, i.e., on the side of the light-transmitting material that is not visible to the user. The front side consequently is perceived by the user as having a constant material width and therefore a particularly attractive appearance. In FIG. 1, the edges of the notch are illustrated in the form of broken lines. The notch or material recess 17 causes the two light emissions to mix in a comparatively limited or short transition area 18 only such that the transition area between the first and the second section is comparatively narrow and therefore clearly defined and easily recognizable.

A scale 19 in the form of an inner, stationary segment of a circle that features numerical values, e.g., a temperature scale, is arranged concentric to the rotary controller 4. When the rotary controller 4 is actuated, it turns about its axis of rotation 20. In this case, the scale does not rotate together with the rotary controller, but rather remains stationary.

The light emitted into the two sections 7, 8 of the light-transmitting material 14 is generated by lamps 23, 24 arranged on the ends 21, 22. These lamps emit light into the light-transmitting material in the direction of extension 15. The gap 25 between the ends 21, 22 of the illuminating device that is realized in an annular fashion in this exemplary embodiment ensures that light cannot be effectively emitted into the end 22 by the lamp 23 in the form of a bypass.

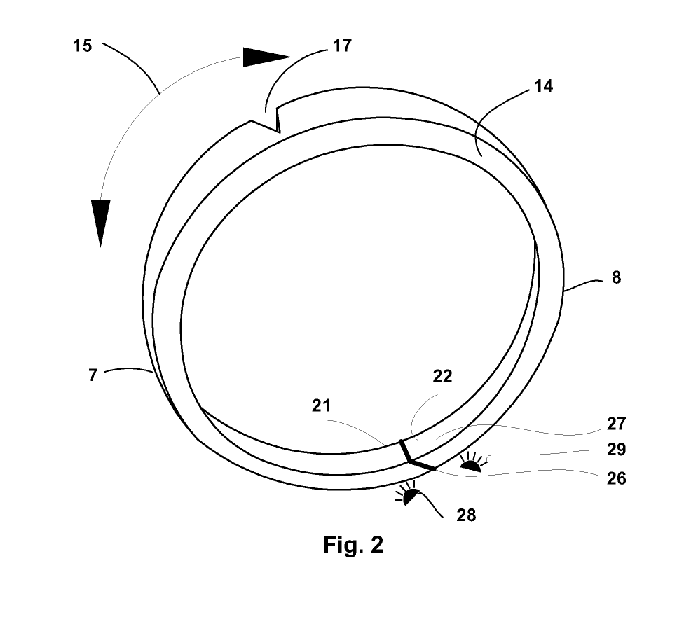

The embodiment of the device illustrated in FIG. 2 shows a lateral oblique view of the light-transmitting material 14 according to FIG. 1. As indicated in FIG. 1, the material recess 17 in the form of a notch is situated on the rear side referred to the viewing direction and extends transverse to the direction of extension 15. The notch forms a very distinctly delimited and defined transition area between the two sections 7, 8. In this case, a narrow slot 26, in which an opaque foil 27 is arranged, or a suitable coating on the face sides that define the slot prevents light emitted by the light sources 28, 29 from respectively reaching the other end along the short path, i.e., not via the material recess 17.

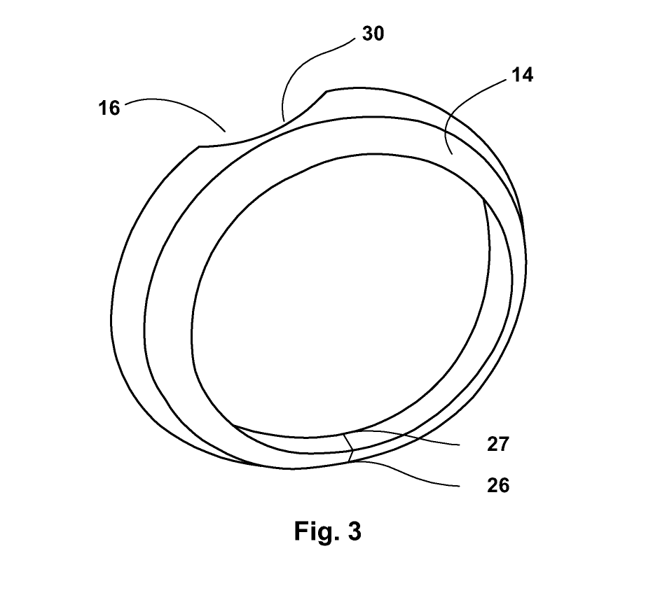

In the embodiment of the device illustrated in FIG. 3, the reduced material thickness 16 of the material 14 is realized with a flattening or indentation in the form of a valley-shaped material recess 30 of the light-transmitting material 14 that extends transverse to the direction of extension on the rear side referred to the viewing direction and therefore is also invisible. The slot 26, in which an opaque foil 27 is arranged, also ensures that light emitted by the (not-shown) light sources is prevented from respectively reaching the other end along the short path.

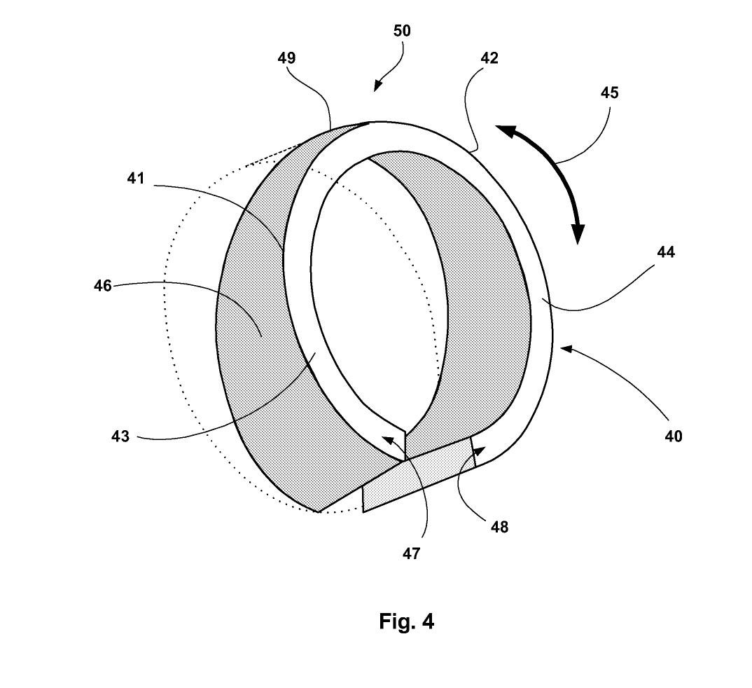

In the embodiment of the device 40 illustrated in FIG. 4, the sections 41 and 42 that differ with respect to their colors 43 and 44 effectively transform into one another continuously due to the fact that the material thickness of the light-transmitting material 46 initially decreases continuously in the direction of extension 45 of the device 40, namely from a first light infeed area 47 to a second light infeed area 48, and then continuously increases once again from a minimum 49. A very mellow transition between the first section 41 that, for example, emits blue light and the section 42 that, for example, emits red light is realized in the form of a (e.g. violet) transition area 50. In this case, the illuminating device may either be arranged stationarily referred to the adjusting mechanism or be connected thereto such that the transition area 50 effectively functions as an adjusting mark or a dial. The annular illuminating device, which once again merely represents one optional design, is slotted between the light infeed areas 47 and 48 in order to prevent the light from respectively propagating to the other infeed area along the short path, i.e., not via the material recess.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An illuminating device for an adjusting mechanism adapted to adjust an operating parameter in a vehicle, comprising
a light-transmitting material extending along the adjusting mechanism and adapted to emit visible light in a first section and a second section;
a light-transmitting transition area of the light-transmitting material with a reduced material thickness between the first section and the second section referred to a direction of extension.

2. The illuminating device according to claim 1, wherein the reduced material thickness comprises a recess extending transverse to the direction of extension.

3. The illuminating device according to claim 2, wherein the recess is situated on a rear side of the light-transmitting material.

4. The illuminating device according to claim 1, wherein the light-transmitting material comprises two ends on which a lamp emits light into the light-transmitting material.

5. The illuminating device according to claim 4, wherein a first light emission of the first section differs from a second light emission of the second section.

6. The illuminating device according to claim 5, wherein a first wavelength of the first light emission differs from a second wavelength of the second light emission.

7. The illuminating device according to claim 5, wherein a first brightness of the first light emission differs from a second brightness of the second light emission.

8. The illuminating device according to claim 1, wherein the light-transmitting material forms a display area.

9. The illuminating device according to claim 8, further comprising a display unit adapted to display a numerically adjusted value is arranged along the display area.

10. The illuminating device according to claim 1, wherein a material thickness of the light-transmitting material initially decreases in a first substantially continuous manner in the direction of extension between a first light infeed area and a second light infeed area and increases in a second substantially continuous manner from a minimum.
